(19) United States
(12) Patent Application Publication
(10) Pub. No.: US 2022/0145973 A1
(43) Pub. Date: May 12, 2022

(54) CONTINUOUSLY VARIABLE TRANSMISSION

(71) Applicant: WEIHAI TUANZHONG TRANSMISSION CO., LTD., WEIHAI (CN)

(72) Inventors: Yongfeng TANG, WEIHAI (CN); Yuning TANG, WEIHAI (CN)

(73) Assignee: WEIHAI TUANZHONG TRANSMISSION CO., LTD., WEIHAI (CN)

(21) Appl. No.: 17/430,596

(22) PCT Filed: Feb. 5, 2020
(86) PCT No.: PCT/CN2020/074339

§ 371 Date: Aug. 12, 2021

(30) Foreign Application Priority Data
Feb. 21, 2019 (CN) 201910128087.3

(51) Int. Cl. F16H 47/12; F16H 57/031; F16H 57/08

(52) U.S. Cl. CPC F16H 47/12; F16H 57/08; F16H 57/031

(57) ABSTRACT

A continuously variable transmission, provided with an outer housing (4), wherein an intermediate housing (402) is arranged in the middle of the outer housing (4), and a first end cover (401) and a second end cover (403) are arranged on the two sides of the intermediate housing (402); the interior of the intermediate housing (402) is of a cavity structure, and an inner cavity body (5) is formed by a cavity in the intermediate housing (402) and the inner sides of the first end cover (401) and the second end cover (403); a first planetary gear (101) is arranged on the inner side of the first end cover (401), and a second planet gear (201) is arranged on the inner side of the second end cover (403); a planetary axle (9) is fixedly arranged in the middle of each of the first planet gear (101) and the second planet gear (201); bucket wheels (301) are fixedly arranged on the planetary axle (9), and the bucket wheels (301) fixedly arranged on the planetary axle (9) form a bucket wheel set (3), which provide a continuously variable transmission in which three control terminals are formed by the outer housing (4), a planetary axle (6) and planetary axle (10). The described continuously variable transmission may be widely used in the field of transmission.

### BACKGROUND OF THE INVENTION

### Field of the Invention

The present invention relates to a mechanical transmission apparatus, and in particularly to a continuously variable transmission.

### Description of the Related Art

An existing continuously variable transmission proposed in granted patent ZL2017205423425 includes an input end planet gear set and an output end planet gear set, a cavity planet carrier is disposed between the input end planet gear set and the output end planet gear set, the cavity planet carrier includes a cavity input end cover and a cavity output end cover, the cavity input end cover is connected to inside of the input end planet gear set, the cavity output end cover is connected to inside of the output end planet gear set, and a bucket wheel cavity housing is fixedly disposed between the cavity input end cover and the cavity output end cover; the input end planet gear set includes an input end sun gear and input end planet gears, the input end sun gear is engaged with the input end planet gears, planet gear connecting shafts are disposed in middle of the input end planet gears, the planet gear connecting shafts pass through the cavity input end cover and are rotatably connected to the cavity input end cover, the planet gear connecting shafts pass through the bucket wheel cavity housing, an input shaft is disposed in middle of the input end sun gear, the input shaft passes through the cavity input end cover and is rotatably connected to the cavity input end cover, and the planet gear connecting shafts pass through the cavity output end cover and are rotatably connected to the cavity output end cover; the output end planet gear set includes an output end sun gear and output end planet gears, the output end sun gear is engaged with the output end planet gears, the output end planet gears are fixedly connected to the planet gear connecting shafts that pass through the cavity output end cover, and an output shaft is disposed in middle of the output end sun gear; a bucket wheel is fixedly provided on the planet gear connecting shaft located inside the bucket wheel cavity housing.

This continuously variable transmission mainly has the following shortcomings:

1. The revolution of the continuously variable transmission has the performance of being subjected to additional control. The planet gear sets at two ends of this technical solution are outside the cavity planet carrier, that is, outside the cavity input end cover and the cavity output end cover. The planet gear sets at two ends limit the positions of the end covers, and it is difficult to control the revolution of the end covers on two sides of the cavity planet carrier.

2. The cavity planet carrier of the continuously variable transmission contains oil therein and has the condition for oil-rich lubrication. The planet gear sets at two ends of this technical solution are outside the cavity planet carrier, that is, outside the cavity input end cover and the cavity output end cover. The engagement transmission of gears of the planet gear sets at two ends is oil-lean lubricated and has loud noise.

3. The continuously variable transmission has different transmission performances formed by exchanging the input end and the output end, and adapts to different occasions. This technical solution fixes the input end and the output end, resulting in a single transmission performance.

4. The inner wall structure of the bucket wheel cavity housing is a functional structure of the continuously variable transmission, and the shape thereof determines the torque transmission capacity of the bucket wheel. This technical solution does not have an inner wall structure solution.

5. When the torque transmission needs to be increased, in a case of unchanging other structures, the solution of replacing a sun gear with a gear ring is not provided to increase the torque transmission. The continuously variable transmission cannot achieve multiple functions and satisfy different working conditions.

### SUMMARY OF THE INVENTION

The present invention is to solve the technical problem that the planet gear sets at two ends of the continuously variable transmission limit the positions of the end covers, and it is difficult to control the revolution of the end covers on two sides of the cavity planet carrier; the engagement transmission of gears of the planet gear sets at two ends is oil-lean lubricated and has loud noise; the input end and the output end are fixed, and the transmission performance is single; there is no inner wall structure solution of the intermediate housing, and the solution of replacing a sun gear with a gear ring to increase the torque transmission is not provided. The present invention provides a continuously variable transmission which has multiple functions and satisfies different working conditions, wherein three control ends are formed by an outer housing, a first shaft and a second shaft, the lubrication for gear engagement is convenient inside the outer housing, a semicircular cavity corresponding to a bucket wheel is provided in an inner wall of an intermediate housing, the bucket wheel is located in the semicircular cavity, and the sun gear is replaced with the gear ring to increase torque transmission.

To this end, the technical solution of the present invention is a continuously variable transmission provided with an outer housing, an intermediate housing is provided in the middle of the outer housing, a first end cover and a second end cover are respectively provided on both sides of the intermediate housing, the inside of the intermediate housing is a cavity structure, and the cavity inside the intermediate housing and insides of the first end cover and the second end cover form an inner cavity; a first shaft penetrates in the middle of the first end cover, the first shaft is rotatably connected to the first end cover, a first sun gear is fixedly provided on the first shaft, the first sun gear is located inside the first end cover, the first sun gear is adjacently provided with a first support frame, a first planet gear is provided on an outer circumference of the first sun gear, the first planet gear is engaged with the first sun gear, and the first planet gear and the first sun gear constitute a first planet gear set; a second shaft penetrates in the middle of the second end cover, the second shaft is rotatably connected to the second end cover, a second sun gear is fixedly provided on the second shaft, the second sun gear is located inside the second end cover, the second sun gear is adjacently provided with a second support frame, a second planet gear is provided on an outer circumference of the second sun gear, the second planet gear is engaged with the second sun gear, and the second planet gear and the second sun gear constitute a second planet gear set; the first planet gear and the second planet gear are fixedly connected through a planet gear shaft, the planet gear shaft penetrates through the first planet gear, the first support frame, the second support frame and the second planet gear in turn, the planet gear shaft is rotatably connected to the first support frame and the second support frame respectively, a bucket wheel is fixedly provided on the planet gear shaft located between the first support frame and the second support frame, and the bucket wheels fixedly provided on a plurality of the planet gear shafts constitute a bucket wheel set.

Preferably, a semicircular cavity is provided in a position corresponding to the bucket wheel in an inner wall of the outer housing, and the bucket wheel is located in the semicircular cavity.

Preferably, there are 3 or more first planet gears.

Preferably, there are 3 or more second planet gears.

Preferably, a central bucket wheel is fixedly provided on the first shaft or the second shaft.

A continuously variable transmission provided with an outer housing, an intermediate housing is provided in the middle of the outer housing, a first end cover and a second end cover are respectively provided on both sides of the intermediate housing, the inside of the intermediate housing is a cavity structure, and the cavity inside the intermediate housing and insides of the first end cover and the second end cover form an inner cavity; a first shaft penetrates in the middle of the first end cover, the first shaft is rotatably connected to the first end cover, a first gear ring is fixedly provided on the first shaft, the first gear ring is located inside the first end cover, the first gear ring is adjacently provided with a first support frame, a first planet gear is provided inside an outer circumference of the first gear ring, the first planet gear is engaged with the first gear ring, and the first planet gear and the first gear ring constitute a first planet gear set; a second shaft penetrates in the middle of the second end cover, the second shaft is rotatably connected to the second end cover, a second gear ring is fixedly provided on the second shaft, the second gear ring is located inside the second end cover, the second gear ring is adjacently provided with a second support frame, a second planet gear is provided inside an outer circumference of the second gear ring, the second planet gear is engaged with the second gear ring, and the second planet gear and the second gear ring constitute a second planet gear set; the first planet gear and the second planet gear are fixedly connected through a planet gear shaft, the planet gear shaft penetrates through the first planet gear, the first support frame, the second support frame and the second planet gear in turn, the planet gear shaft is rotatably connected to the first support frame and the second support frame respectively, a bucket wheel is fixedly provided on the planet gear shaft located between the first support frame and the second support frame, and the bucket wheels fixedly provided on a plurality of the planet gear shafts constitute a bucket wheel set.

A continuously variable transmission is provided with an outer housing, an intermediate housing is provided in the middle of the outer housing, a first end cover and a second end cover are respectively provided on both sides of the intermediate housing, the inside of the intermediate housing is a cavity structure, and the cavity inside the intermediate housing and insides of the first end cover and the second end cover form an inner cavity; a first shaft penetrates in the middle of the first end cover, the first shaft is rotatably connected to the first end cover, a first sun gear is fixedly provided on the first shaft, the first sun gear is located inside the first end cover, the first sun gear is adjacently provided with a first support frame, a first planet gear is provided on an outer circumference of the first sun gear, the first planet gear is engaged with the first sun gear, and the first planet gear and the first sun gear constitute a first planet gear set; a second shaft penetrates in the middle of the second end cover, the second shaft is rotatably connected to the second end cover, a second gear ring is fixedly provided on the second shaft, the second gear ring is located inside the second end cover, the second gear ring is adjacently provided with a second support frame, a second planet gear is provided inside an outer circumference of the second gear ring, the second planet gear is engaged with the second gear ring, and the second planet gear and the second gear ring constitute a second planet gear set; the first planet gear and the second planet gear are fixedly connected through a planet gear shaft, the planet gear shaft penetrates through the first planet gear, the first support frame, the second support frame and the second planet gear in turn, the planet gear shaft is rotatably connected to the first support frame and the second support frame respectively, a bucket wheel is fixedly provided on the planet gear shaft located between the first support frame and the second support frame, and the bucket wheels fixedly provided on a plurality of the planet gear shafts constitute a bucket wheel set.

Preferably, a semicircular cavity is provided in a position corresponding to the bucket wheel in an inner wall of the outer housing, and the bucket wheel is located in the semicircular cavity.

The benefit effects of the present invention are as follows. An outer housing is provided, an intermediate housing is provided in the middle of the outer housing, a first end cover and a second end cover are respectively provided on both sides of the intermediate housing, the inside of the intermediate housing is a cavity structure, and the cavity inside the intermediate housing and insides of the first end cover and the second end cover form an inner cavity; a first shaft penetrates in the middle of the first end cover, the first shaft is rotatably connected to the first end cover, a first sun gear is fixedly provided on the first shaft, the first sun gear is located inside the first end cover, the first sun gear is adjacently provided with a first support frame, a first planet gear is provided on an outer circumference of the first sun gear, the first planet gear is engaged with the first sun gear, and the first planet gear and the first sun gear constitute a first planet gear set; a second shaft penetrates in the middle of the second end cover, the second shaft is rotatably connected to the second end cover, a second sun gear is fixedly provided on the second shaft, the second sun gear is located inside the second end cover, the second sun gear is adjacently provided with a second support frame, a second planet gear is provided on an outer circumference of the second sun gear, the second planet gear is engaged with the second sun gear, and the second planet gear and the second sun gear constitute a second planet gear set; the first planet gear and the second planet gear are fixedly connected through a planet gear shaft, the planet gear shaft penetrates through the first planet gear, the first support frame, the second support frame and the second planet gear in turn, the planet gear shaft is rotatably connected to the first support frame and the second support frame respectively, a bucket wheel is fixedly provided on the planet gear shaft located between the first support frame and the second support frame, and the bucket wheels fixedly provided on the planet gear shafts constitute a bucket wheel set. The outer housing, the first shaft and the second shaft respectively form three control ends, and the outer housing, the first shaft and the second shaft can also be conveniently selected as input and output functions respectively. When the transmission torque capacity is insufficient, the function of the third control end participating in braking and the like will greatly improve the performance of the continuously variable transmission. The first planet gear set, the second planet gear set, the bucket wheel and other parts are all located in the inner cavity of the outer housing, and the gear engagement has oil-rich lubrication. The gear ring can replace the sun gear, which greatly improves the torque transmission performance. The bucket wheel is located in the semicircular cavity on the inner wall of the intermediate housing, and the hydrodynamic force and the hydrodynamic viscous force of the bucket wheel will exert more effective performance, so that multiple functions and high performance of the continuously variable transmission can be achieved and different working conditions requirements are satisfied.

### BRIEF DESCRIPTION OF THE DRAWINGS

FIG. 1 is an axonometric view of Embodiment 1 of the present invention;

FIG. 2 is a section view of FIG. 1;

FIG. 3 is a section view of FIG. 2;

FIG. 4 is a schematic view of internal structure after removing an outer housing;

FIG. 5 is an axonometric view of Embodiment 2 of the present invention;

FIG. 6 is a section view of FIG. 5;

FIG. 7 is a section view of FIG. 6;

FIG. 8 is a schematic view of internal structure after removing an outer housing.

Symbols in the drawings:

1. first planet gear set; 101. first planet gear; 102. first sun gear; 102A. first gear ring; 2. second planet gear set; 201. second planet gear; 202. second sun gear; 202A. second gear ring; 3. bucket wheel set; 301. bucket wheel; 4. outer housing; 401. first end cover; 402. intermediate housing; 403. second end cover; 5. inner cavity; 6. first shaft; 7. first support frame; 8. second support frame; 9. planet gear shaft; 10. second shaft; 11. central bucket wheel.

### DESCRIPTION OF THE EMBODIMENTS

The present invention will be further described below in conjunction with the embodiments.

### Embodiment 1

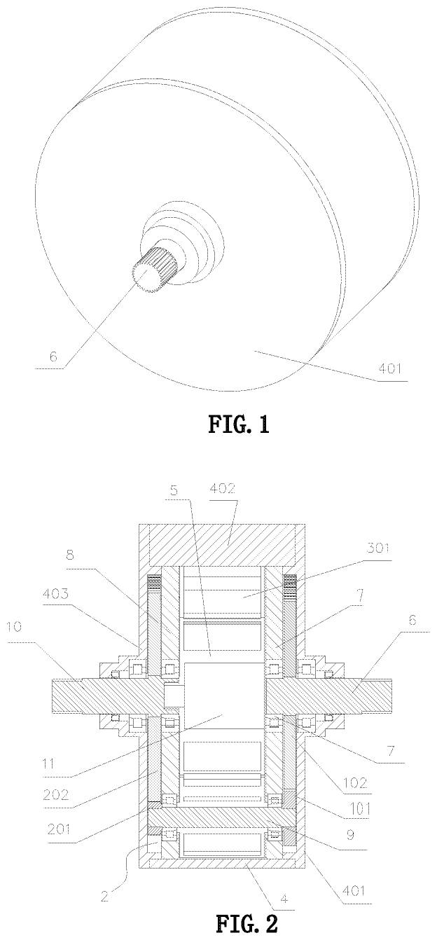

FIGS. 1-4 show a continuously variable transmission of the present invention. An intermediate housing 402 is provided in the middle of the outer housing 4, a first end cover 401 and a second end cover 403 are respectively provided on both sides of the intermediate housing 402, the inside of the intermediate housing 402 is a cavity structure, and the cavity inside the intermediate housing 402 and insides of the first end cover 401 and the second end cover 402 form an inner cavity 5; a first shaft 6 penetrates in the middle of the first end cover 401, the first shaft 6 is rotatably connected to the first end cover 401, a first sun gear 102 is fixedly provided on the first shaft 6, the first sun gear 102 is located inside the first end cover 401, the first sun gear 102 is adjacently provided with a first support frame 7, a first planet gear 101 is provided on an outer circumference of the first sun gear 102, the first planet gear 101 is engaged with the first sun gear 102, and the first planet gear 101 and the first sun gear 102 constitute a first planet gear set 1; a second shaft 10 penetrates in the middle of the second end cover 403, the second shaft 10 is rotatably connected to the second end cover 403, a second sun gear 202 is fixedly provided on the second shaft 10, the second sun gear 202 is located inside the second end cover 403, the second sun gear 202 is adjacently provided with a second support frame 8, a second planet gear 201 is provided on an outer circumference of the second sun gear 202, the second planet gear 201 is engaged with the second sun gear 202, and the second planet gear 201 and the second sun gear 202 constitute a second planet gear set 2; the first planet gear 101 and the second planet gear 201 are fixedly connected through a planet gear shaft 9, the planet gear shaft 9 penetrates through the first planet gear 101, the first support frame 7, the second support frame 8 and the second planet gear 201 in turn, the planet gear shaft 9 is rotatably connected to the first support frame 7 and the second support frame 8 respectively, a bucket wheel 301 is fixedly provided on the planet gear shaft 9 located between the first support frame 7 and the second support frame 8, the bucket wheels 301 fixedly provided on a plurality of the planet gear shafts 9 constitute a bucket wheel set 3, and the inner cavity 5 contains a moderate amount of oil therein.

This embodiment is an improvement on the basis of the granted patent ZL2017205423425. In this embodiment, the continuously variable transmission is provided with the outer housing 4, the intermediate housing 402 is provided in the middle of the outer housing 4, the first end cover 401 and the second end cover 403 are respectively provided on both sides of the intermediate housing 402, the inside of the intermediate housing 402 is the cavity structure, and the cavity inside the intermediate housing 402 and insides of the first end cover 401 and the second end cover 402 form the inner cavity 5. The continuously variable transmission itself has functions of revolution and rotation. In order to achieve intervention control on the revolution of the continuously variable transmission, in this embodiment, the first planet gear set 1, the second planet gear set 2, the bucket wheel set 3 and other components are all placed in the inner cavity 5, and the inner cavity 5 is a closed structure, so that the outer housing 4 becomes a control end easy to be controlled. When the continuously variable transmission is operating, different torques are applied to the outer housing 4, so as to control the revolution of the continuously variable transmission. The transmission stress state of the first planet gear set 1 and the second planet gear set 2 can be changed by the first support frame 7 and the second support frame 8. By adjusting size of the output torque and output state of the continuously variable transmission, the transmission performance of the continuously variable transmission is greatly enhanced and improved.

When the continuously variable transmission is operating, the outer housing 4 can operate in an adaptive state. At the same time, the outer housing 4 can also form a power end and a control end independent of each other, that is, the outer housing 4 has three functions of a power output end, a control end for applying brakes, and an adaptive control end, so as to improve the control of the transmission performance of the continuously variable transmission, adjust it to various transmission forms, and satisfy the application in different fields and different occasions.

At the same time, when applying the continuously variable transmission, the first shaft 6 or the second shaft 10 can be interchanged as the input end and the output end, and the continuously variable transmission has different performances.

As can be seen from the above structure, the first planet gear set 1, the second planet gear set 2, the bucket wheel set 3 and other components are all located in the inner cavity 5, and the inner cavity 5 is a closed structure containing oil. When the continuously variable transmission operates, the first planet gear set 1, the second planet gear set 2, the bucket wheel set 3 and other components can be sufficiently lubricated to reduce mechanical wear and noise.

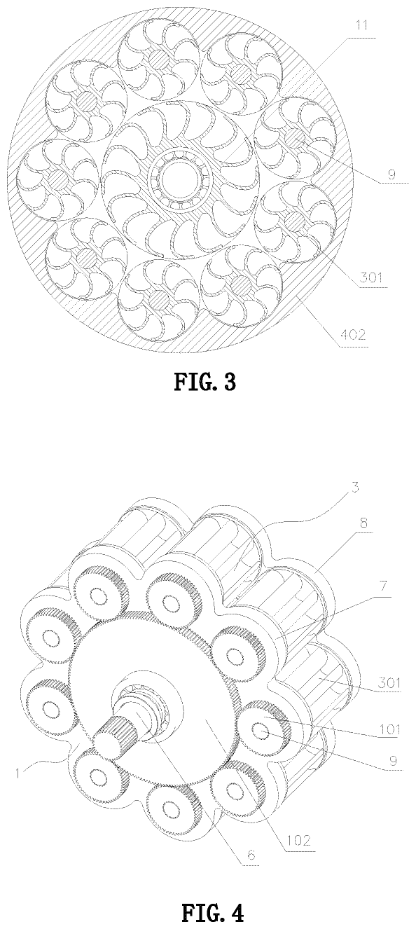

As can be seen in FIG. 3, a semicircular cavity is provided in a position corresponding to the bucket wheel 301 in an inner wall of the outer housing 4, and the bucket wheel 301 is located in the semicircular cavity. With such a structure, when the bucket wheel 301 rotates to operate, the hydrodynamic viscous force and the hydrodynamic force of the oil in the bucket wheel 301 and the inner cavity 5 can be fully used. The hydrodynamic viscous force and the hydrodynamic force will exert more effective performance. The compact optimization of volume is achieved and the better performance is satisfied, so that the continuously variable transmission outputs maximum power and torque.

As can be seen in FIG. 3, a central bucket wheel 11 is fixedly provided on the first shaft 6 or the second shaft 10. Providing the central bucket wheel 11 can adjust the operation mode of the oil in the inner cavity 5 and adjust the operation performance.

The operation process of the continuously variable transmission is as follows. When starting, the power is input clockwise from the first shaft 6, the first shaft 6 drives the first sun gear 102 to rotate clockwise, the first sun gear 102 drives the first planet gear 101 to rotate counterclockwise, and the first planet gear 101 drives the second planet gear 201 to rotate through the fixedly connected planet gear shaft 9. When the second sun gear 202 receives resistance from the second shaft 10, the second planet gear 201 revolves counterclockwise around the second sun gear 202 and drives the outer housing 4 to revolve counterclockwise. The bucket wheel 301 fixed on the planet wheel shaft 9 rotates counterclockwise. The bucket wheel 301 is located in the semicircular cavity on the inner wall of the intermediate housing 402. The bucket wheel 301 is subjected to a resistance of the oil in the intermediate housing 402 to form a torque, and this resistance includes hydrodynamic gravity formed by the revolution of the oil in the intermediate housing 402, hydrodynamic force due to oil injection from the bucket wheel 301 to the adjacent bucket wheel 301, and hydrodynamic viscous force of oil between the bucket wheel 301 and the semicircular cavity on the inner wall of the intermediate housing 402. The torque is transmitted to the first sun gear 102 and the second sun gear 202 through the planet gear shaft 9. This resistance torque is also transmitted to the outer housing 4, thereby forming a torque that prevents the outer housing 4 from revolving, and driving the second planet gear 201 to apply force to the second sun gear 202. The second sun gear 202 drives the second shaft 10 to output power. The resistance of the oil to the bucket wheel 301 starts at 0, and increases exponentially as the speed of the first shaft 6 increases, so that the second sun gear 202 drives the second shaft 10 to rotate, and the power is output through the second shaft 10. When the resistance of the oil in the intermediate housing 402 received by the bucket wheel 301 is not enough to prevent the outer housing 4 from revolving, the outer housing 4 is braked, and the input force of the first shaft 6 is quickly transmitted to the second shaft 10 to output power.

When the above continuously variable transmission is operating, the continuously variable transmission is in the zero-speed and zero-torque start state at the initial stage of starting. At the middle stage of starting, the resistance to the bucket wheel set 3 increases rapidly, and the resistance finally acts on the first support frame 7 and the second support frame 8, and also acts on the intermediate housing 402. When the input end is at a low rotational speed, the resistance provided by the bucket wheel set 3 is not enough, and the output torque is small. At this time, an external braking force is applied to any part of the first end cover 401, the second end cover 403 and the intermediate housing 402 of the outer housing 4, and the external braking force and the resistance torque of the bucket wheel 8 participate in preventing the outer housing 4 from revolving, so that the need for the bucket wheel 301 to provide resistance is reduced and the output end can output the maximum torque. When the outer housing 4 applies half brake, the continuously variable transmission can realize the continuously variable speed control function at this time. When the outer housing 4 applies full brake, the continuously variable transmission can realize the reducer function at this time. Under the rated working condition, the rotational speed and torque of the continuously variable transmission are relatively stable, the bucket wheel 301 is in a force balance state and will not rotate, and the mutual gears do not rotate. At this time, the continuously variable transmission can achieve synchronous transmission of overall power, which is close to 1:1 transmission.

Compared with the technical solution in the patent ZL2017205423425, in the technical solution of this embodiment, any one of the first shaft 6, the second shaft 10 and the outer housing 4 can be selected as the input power part, the other two can be the output power part and the control output part respectively, and the application is very flexible. At the same time, it is possible to control the transmission mode of the continuously variable transmission, improve and control the output performance, and satisfy the requirements in various transmission fields.

This series of continuously variable transmission may adopt 3 or more first planet gears 101 and second planet gears 201. In this embodiment, there are nine first planet gears 101 and nine second planet gears 201. Different numbers of the first planet gears 101 and the second planet gears 201 can be set according to transmitted power and used size, so as to adapt to different application requirements. Generally, different numbers can be selected, such as 6, 9, 12, and the like. It has been proved by test that, when the power of about 100 kw needs to be transmitted, 6 first planet gears 101 can be used to constitute a planet gear set consisting of 6 first planet gears 101, and the performance of the continuously variable transmission is more optimized.

### Embodiment 2

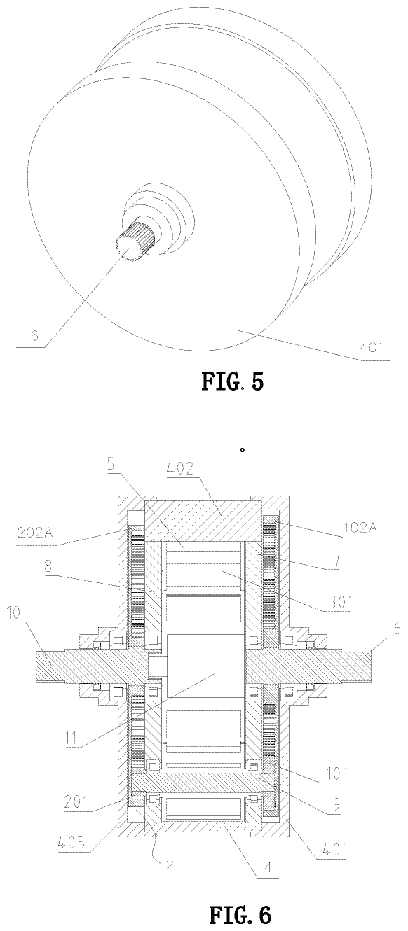

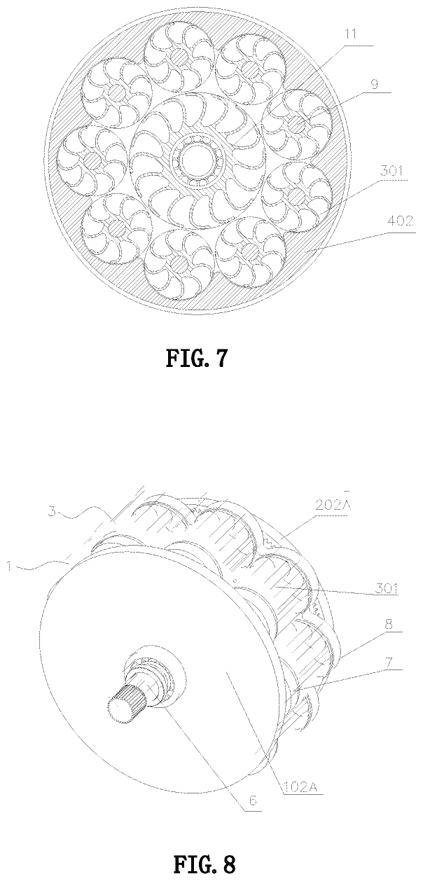

FIGS. 5-8 show another embodiment of a continuously variable transmission of the present invention. An intermediate housing 402 is provided in the middle of the outer housing 4, a first end cover 401 and a second end cover 403 are respectively provided on both sides of the intermediate housing 402, the inside of the intermediate housing 402 is a cavity structure, and the cavity inside the intermediate housing 402 and insides of the first end cover 401 and the second end cover 402 form an inner cavity 5; a first shaft 6 penetrates in the middle of the first end cover 401, the first shaft 6 is rotatably connected to the first end cover 401, a first gear ring 102A is fixedly provided on the first shaft 6, the first gear ring 102A is located inside the first end cover 401, the first gear ring 102A is adjacently provided with a first support frame 7, a first planet gear 101 is provided inside an outer circumference of the first gear ring 102A, the first planet gear 101 is engaged with the first gear ring 102A, and the first planet gear 101 and the first gear ring 102A constitute a first planet gear set 1; a second shaft 10 penetrates in the middle of the second end cover 403, the second shaft 10 is rotatably connected to the second end cover 403, a second gear ring 202A is fixedly provided on the second shaft 10, the second gear ring 202A is located inside the second end cover 403, the second gear ring 202A is adjacently provided with a second support frame 8, a second planet gear 201 is provided inside an outer circumference of the second gear ring 202A, the second planet gear 201 is engaged with the second gear ring 202A, and the second planet gear 201 and the second gear ring 202A constitute a second planet gear set 2; the first planet gear 101 and the second planet gear 201 are fixedly connected through a planet gear shaft 9, the planet gear shaft 9 penetrates through the first planet gear 101, the first support frame 7, the second support frame 8 and the second planet gear 201 in turn, the planet gear shaft 9 is rotatably connected to the first support frame 7 and the second support frame 8 respectively, a bucket wheel 301 is fixedly provided on the planet gear shaft 9 located between the first support frame 7 and the second support frame 8, and the bucket wheels 301 fixedly provided on a plurality of the planet gear shafts 9 constitute a bucket wheel set 3.

As can be seen in FIG. 6, the differences from Embodiment 1 are in that the first sun gear 102 in Embodiment 1 is replaced with the first gear ring 102A in this embodiment, and the second sun gear 202 in Embodiment 1 is replaced with the second gear ring 202A in this embodiment. When the power is input from the first shaft 6 or the second shaft 10, since the outer diameters of the first gear ring 102A and the second gear ring 202A are larger than those of the first sun gear 102 and the second sun gear 202, the transmitted torque is large, and the efficiency of engagement transmission between the gear ring and the planet gear is higher than that between the sun gear and the planet gear, which can well improve the power transmission performance of the continuously variable transmission, and is more suitable for field applications that need to transmit greater power and torque.

It has been verified by test that, this embodiment increases the torque transmission capacity by about 40%, while reducing the damage of centrifugal force of the first planet gear 101 and the second planet gear 201 during operation. At the same time, the lubrication performance is better, and the application of different working conditions of the continuously variable transmission can be satisfied.

### Embodiment 3

With reference to FIGS. 2 and 6, another Embodiment 3 of a continuously variable transmission can be formed. An intermediate housing 402 is provided in the middle of the outer housing 4, a first end cover 401 and a second end cover 403 are respectively provided on both sides of the intermediate housing 402, the inside of the intermediate housing 402 is a cavity structure, and the cavity inside the intermediate housing 402 and insides of the first end cover 401 and the second end cover 402 form an inner cavity 5; a first shaft 6 penetrates in the middle of the first end cover 401, the first shaft 6 is rotatably connected to the first end cover 401, a first sun gear 102 is fixedly provided on the first shaft 6, the first sun gear 102 is located inside the first end cover 401, the first sun gear 102 is adjacently provided with a first support frame 7, a first planet gear 101 is provided on an outer circumference of the first sun gear 102, the first planet gear 101 is engaged with the first sun gear 102, and the first planet gear 101 and the first sun gear 102 constitute a first planet gear set 1; a second shaft 10 penetrates in the middle of the second end cover 403, the second shaft 10 is rotatably connected to the second end cover 403, a second gear ring 202A is fixedly provided on the second shaft 10, the second gear ring 202A is located inside the second end cover 403, the second gear ring 202A is adjacently provided with a second support frame 8, a second planet gear 201 is provided inside an outer circumference of the second gear ring 202A, the second planet gear 201 is engaged with the second gear ring 202A, and the second planet gear 201 and the second gear ring 202A constitute a second planet gear set 2; the first planet gear 101 and the second planet gear 201 are fixedly connected through a planet gear shaft 9, the planet gear shaft 9 penetrates through the first planet gear 101, the first support frame 7, the second support frame 8 and the second planet gear 201 in turn, the planet gear shaft 9 is rotatably connected to the first support frame 7 and the second support frame 8 respectively, a bucket wheel 301 is fixedly provided on the planet gear shaft 9 located between the first support frame 7 and the second support frame 8, and the bucket wheels 301 fixedly provided on a plurality of the planet gear shafts 9 constitute a bucket wheel set 3.

Embodiment 3 combines Embodiment 1 with Embodiment 2, and replaces the first sun gear 102 corresponding to the first shaft 6 or the second sun gear 202 corresponding to the second shaft 10 in the embodiment 1 with the first gear ring 102A or the second gear ring 202A. That is, the technical solution of the continuously variable transmission in Embodiment 3 is that only the sun gear of the first shaft 6 or the second shaft 10 is replaced with a gear ring, so that the power transmission performance can be designed more flexibly, and can be adjusted to different transmission parameters and performances to satisfy the mechanical transmission requirements of various fields.

The above are only the specific embodiments of the present invention, and the scope of the present invention is not limited thereto, and thus all of the replacement of the equivalent components thereof, or the equivalent changes and modifications made according to the claimed scope of the present invention should still fall within the scope encompassed by the claims of the present invention.

1. A continuously variable transmission provided with an outer housing, characterized in that, an intermediate housing is provided in the middle of the outer housing, a first end cover and a second end cover are respectively provided on both sides of the intermediate housing, the inside of the intermediate housing is a cavity structure, and the cavity inside the intermediate housing and insides of the first end cover and the second end cover form an inner cavity;
a first shaft penetrates in the middle of the first end cover, the first shaft is rotatably connected to the first end cover, a first sun gear is fixedly provided on the first shaft, the first sun gear is located inside the first end cover, the first sun gear is adjacently provided with a first support frame, a first planet gear is provided on an outer circumference of the first sun gear, the first planet gear is engaged with the first sun gear, and the first planet gear and the first sun gear constitute a first planet gear set;
a second shaft penetrates in the middle of the second end cover, the second shaft is rotatably connected to the second end cover, a second sun gear is fixedly provided on the second shaft, the second sun gear is located inside the second end cover, the second sun gear is adjacently provided with a second support frame, a second planet gear is provided on an outer circumference of the second sun gear, the second planet gear is engaged with the second sun gear, and the second planet gear and the second sun gear constitute a second planet gear set;
the first planet gear and the second planet gear are fixedly connected through a planet gear shaft, the planet gear shaft penetrates through the first planet gear, the first support frame, the second support frame and the second planet gear in turn, the planet gear shaft is rotatably connected to the first support frame and the second support frame respectively, a bucket wheel is fixedly provided on the planet gear shaft located between the first support frame and the second support frame, and the bucket wheels fixedly provided on a plurality of the planet gear shafts constitute a bucket wheel set.

2. The continuously variable transmission according to claim 1, characterized in that, a semicircular cavity is provided in a position corresponding to the bucket wheel in an inner wall of the outer housing, and the bucket wheel is located in the semicircular cavity.

3. The continuously variable transmission according to claim 1, characterized in that, there are 3 or more first planet gears.

4. The continuously variable transmission according to claim 1, characterized in that, there are 3 or more second planet gears.

5. The continuously variable transmission according to claim 1, characterized in that, a central bucket wheel is fixedly provided on the first shaft or the second shaft.

6. A continuously variable transmission provided with an outer housing, characterized in that, an intermediate housing is provided in the middle of the outer housing, a first end cover and a second end cover are respectively provided on both sides of the intermediate housing, the inside of the intermediate housing is a cavity structure, and the cavity inside the intermediate housing and insides of the first end cover and the second end cover form an inner cavity;
a first shaft penetrates in the middle of the first end cover, the first shaft is rotatably connected to the first end cover, a first gear ring is fixedly provided on the first shaft, the first gear ring is located inside the first end cover, the first gear ring is adjacently provided with a first support frame, a first planet gear is provided inside an outer circumference of the first gear ring, the first planet gear is engaged with the first gear ring, and the first planet gear and the first gear ring constitute a first planet gear set;
a second shaft penetrates in the middle of the second end cover, the second shaft is rotatably connected to the second end cover, a second gear ring is fixedly provided on the second shaft, the second gear ring is located inside the second end cover, the second gear ring is adjacently provided with a second support frame, a second planet gear is provided inside an outer circumference of the second gear ring, the second planet gear is engaged with the second gear ring, and the second planet gear and the second gear ring constitute a second planet gear set;
the first planet gear and the second planet gear are fixedly connected through a planet gear shaft, the planet gear shaft penetrates through the first planet gear, the first support frame, the second support frame and the second planet gear in turn, the planet gear shaft is rotatably connected to the first support frame and the second support frame respectively, a bucket wheel is fixedly provided on the planet gear shaft located between the first support frame and the second support frame, and the bucket wheels fixedly provided on a plurality of the planet gear shafts constitute a bucket wheel set.

7. A continuously variable transmission provided with an outer housing, characterized in that, an intermediate housing is provided in the middle of the outer housing, a first end cover and a second end cover are respectively provided on both sides of the intermediate housing, the inside of the intermediate housing is a cavity structure, and the cavity inside the intermediate housing and insides of the first end cover and the second end cover form an inner cavity;
a first shaft penetrates in the middle of the first end cover, the first shaft is rotatably connected to the first end cover, a first sun gear is fixedly provided on the first shaft, the first sun gear is located inside the first end cover, the first sun gear is adjacently provided with a first support frame, a first planet gear is provided on an outer circumference of the first sun gear, the first planet gear is engaged with the first sun gear, and the first planet gear and the first sun gear constitute a first planet gear set;
a second shaft penetrates in the middle of the second end cover, the second shaft is rotatably connected to the second end cover, a second gear ring is fixedly provided on the second shaft, the second gear ring is located inside the second end cover, the second gear ring is adjacently provided with a second support frame, a second planet gear is provided inside an outer circumference of the second gear ring, the second planet gear is engaged with the second gear ring, and the second planet gear and the second gear ring constitute a second planet gear set;
the first planet gear and the second planet gear are fixedly connected through a planet gear shaft, the planet gear shaft penetrates through the first planet gear, the first support frame, the second support frame and the second planet gear in turn, the planet gear shaft is rotatably connected to the first support frame and the second support frame respectively, a bucket wheel is fixedly provided on the planet gear shaft located between the first support frame and the second support frame, and the bucket wheels fixedly provided on a plurality of the planet gear shafts constitute a bucket wheel set.

8. The continuously variable transmission according to claim 6, characterized in that, a semicircular cavity is provided in a position corresponding to the bucket wheel in an inner wall of the outer housing, and the bucket wheel is located in the semicircular cavity.
